(19) United States
(12) Patent Application Publication
(10) Pub. No.: US 2004/0199835 A1
(43) Pub. Date: Oct. 7, 2004

(54) Reception device for evaluating the performance of the paths via which receives signals originating from one and the same soooource and method therefore

(76) Inventors: Maxim Belotserkovsky, Indianapolis, IN (US); Vincent Demoulin, Pleumeleuc (FR)

Correspondence Address: Joseph S Tripoli, Thomson Liscensing Inc, Patent Department, P O Box 5312, Priceton, NJ, 08543-5312, US

(21) Appl. No.: 10/481,343

(22) PCT Filed: Jun. 18, 2002
(86) PCT No.: PCT/EP02/06695

(30) Foreign Application Priority Data
Jun. 25, 2001 (FR) 01/08505

(51) Int. Cl. G06F 11/00

(52) U.S. Cl. 714/704

(57) ABSTRACT

Device furnished with at least two paths for receiving signals, with means for correcting errors affecting the signals received, and means of evaluation of the level of performance in terms of reproduction of signals for a path, these means of evaluation determining the performance level of each path. The device also comprises means for degrading, before evaluation and correction, the signals received at the level of a path, so as to reduce the performance level obtained before correction for this path and to allow evaluation of a safety margin relating to the performance level for this path, with the aid of the means of evaluation.

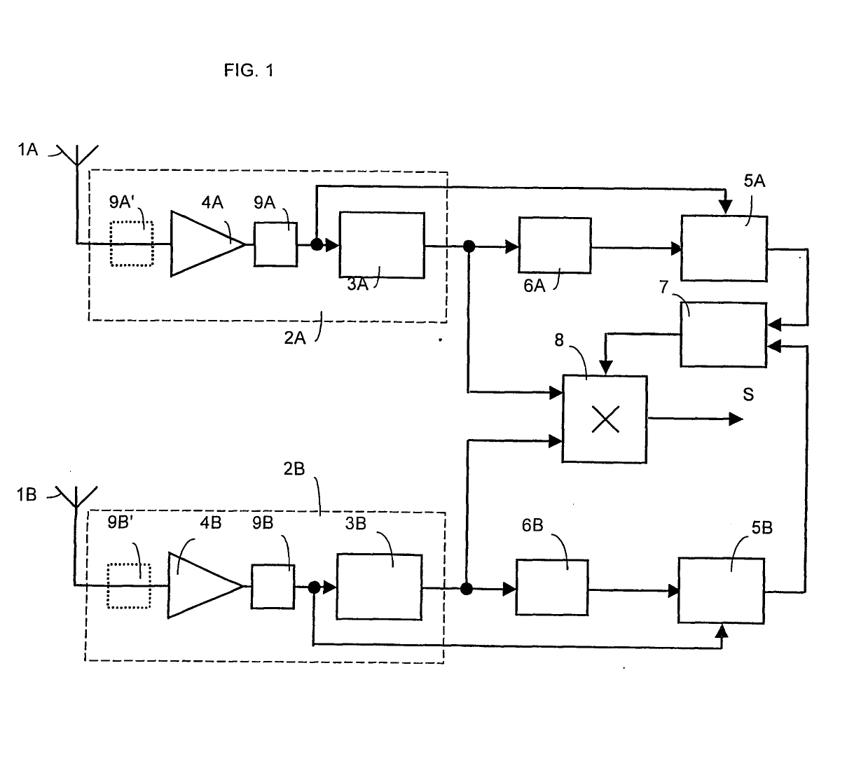

The invention relates to a reception device which is equipped with means designed to allow it to evaluate the performance of the paths via which it receives signals, in particular in the case of digital signals, these evaluations being, for example, designed for the purposes of selecting a better path. It also relates to a process for utilizing this device.

It is known to associate with a device, designed to be able to receive signals via various paths, means making it possible to evaluate the respective performance of these paths, for example in terms of power. These evaluations can be performed for various purposes, they are commonly used to select the antenna by way of which a signal is received with the greatest power by a radio reception device furnished with several antennas. Another known example relates to the case where a device receives digital signals, there is provision therein to calculate the binary error rate or BER for each of the paths capable of being utilized for one and the same reception. A comparison of the rates obtained for the various possible paths for reaching the reception device makes it possible to determine that path or those of the paths for which the lowest error rate is obtained under specified conditions, and consequently to act appropriately.

In the case mentioned hereinabove as an example and by considering the performance criterion taken into account, a path of maximum quality is a path for which the binary error rate which is determined is zero. By default, the best path is a path for which the binary error rate determined turns out to be the lowest compared with those which are obtained under the same conditions for the other paths. It is of course possible for one and the same error rate to be obtained for several paths, thereby making it necessary to carry out a complementary selection based on a different criterion. A simple solution, commonly implemented, for selecting one path from among several possible ones, consists in selecting the first path for which a zero error rate, or one regarded as sufficiently low, is determined.

The means for evaluating quality for the reception paths alluded to hereinabove have the drawback of not supplying any indication relating to the safety margins, in terms of performance, respectively available for paths which simultaneously exhibit the same quality, that is to say the same performance level, according to a specified criterion and, in particular, one and the same binary error rate. Now, in particular, within the framework of path selection as a function of the quality thereof, it is advantageous to choose the path which exhibits the greatest safety margin, when the signal to be transmitted is capable of varying over time in a manner which significantly affects its quality. If this safety margin is not taken into account in determining the best path for a reception device, there is a risk of the degradation affecting a signal received via a path not allowing its utilization or its optimal utilization by the device for which it is intended, although reception carried out via another path may allow it, if the safety margin available at the level of this other path is larger than that allowed by the selected path.

The invention therefore proposes a reception device furnished with at least two paths for receiving signals, means making it possible to correct errors possibly affecting the signals received via a path, by utilizing indications incorporated into these signals, and means for evaluating the level of performance achieved according to a specified criterion of quality in terms of reproduction of signals for a path, these means of evaluation being utilized to determine the performance level capable of being obtained after correction for each path. The device also comprises means making it possible to degrade, before evaluation and correction, the signals received at the level of a path so as to be able to reduce the said performance level obtained for this path and to allow, consequently, evaluation of a safety margin, according to the quality criterion, for this path, with the aid of the means of evaluation.

According to a variant of the invention, the device comprises means for degrading the signals received which are utilized in time-sharing mode between all or at least some of the paths, and also at least certain of the means for correcting the errors and evaluating the performance levels and safety margins which relate to the paths constituting the said all or some of the paths and with which the said degradation means are associated.

The invention also proposes a process allowing the evaluation of the performance in terms of reproduction of the signals received by a device furnished with several paths via which the signals are capable of being received, this device comprising means for correcting the signals received via a path, within specified limits of correction, by utilizing indications incorporated into the signals and means for evaluating the performance of a path according to a specified criterion of quality in terms of reproduction of signals, before correction. Provision is made to degrade the signals received so as to make it possible to determine a safety margin per path, according to the quality criterion taken into account by the evaluation means, when the degradation imposed on the signals received via a path causes the variation of the performance level evaluated for this path.

The invention, its characteristics and its advantages are specified in the description which follows in conjunction with the single FIGURE alluded to hereinbelow.

The single FIGURE depicts a basic diagram relating to an exemplary reception device endowed with evaluation means, according to the invention.

For the convenience of explanation, it is assumed that the diversity reception device depicted in the single FIGURE is furnished with two paths each symbolized by an antenna 1A or 1B linked to an individual arrangement 2A or 2B included in the device. In fact, the invention applies equally when the reception device is designed to be able to receive signals from a number of paths which is greater than two and when the device is designed to cater, in a multiplex manner, for all or some of the processing of the signals, received from various paths, which is envisaged here. As known, such multiplexing can make it possible to limit to just one the number of functional modules required for carrying out a specified function and for example a decoding or an error rate calculation, whereas one module per function is provided for each path, in the basic diagram depicted here. Such time division multiplexing can be applied only if the digital signals are transmitted in packets.

In the example depicted and according to a known embodiment relating to a device for receiving digital signals, the signals picked up by an antenna are applied to the input of a decoder 3A or 3B, after having been reshaped appropriately by way of an interface module 4A or 4B, catering for their amplification and their frequency and time synchronization with a view to their being taken into account by the decoder.

It is assumed here that the signals contain error correcting codes introduced before dispatch to the reception device, so as to allow a decoder to correct most of the errors occurring in the signals received which were not present before dispatch. The use of error correcting code is common in digital transmissions. Various correcting codes can be used with the invention.

In the example envisaged here, the signals are grouped into packets which contain the error correcting codes, the latter allowing a decoder to correct at least certain of the errors occurring in the packets received which were not present when these packets were constructed. The signals appearing successively at the output of a decoder, designed to utilize such an error correcting technique conventionally designated by the acronym FEC standing for “Forward Error Correction”, therefore contain only few errors, or even no error, when the conditions of utilization correspond to what is normally provided for.

An evaluation of the performance of a decoder is carried out, for example, by means of an evaluation module 5A or 5B, here linked both to the input and to the output of this decoder. In the example proposed, the output of the decoder is linked to the evaluation module by way of a coder 6A or 6B, operating in an inverse manner with respect to the decoder. This coder makes it possible to recode the decoded packets appearing at the output of the decoder so as to be able to compare them with the packets received from which they arise. Insofar as, as indicated hereinabove, the packets appearing at the output of a decoder do not normally contain any error, so long as the decoder is operating under acceptable conditions, it is possible to utilize the recoded packets as references in relation to the packets from which they arise. This makes it possible to determine a binary error rate, as alluded to above for a decoder and hence for the path in which the decoder is included, from the packets of signals which this decoder has received.

In the example presented, each of the two modules for evaluating error rates 5A or 5B receives via a first input the packets appearing at the output of one of the interface modules and via a second input the packets exiting one of the coders 6A or 6B. Each evaluation module supplies an error evaluation signal via an output to one of the inputs of a pooled comparator 7. The comparator 7 is here utilized to control a switch 8 making it possible to selectively link up the packet output S of the reception device with the output of one or other of the decoders 3A and 3B. This makes it possible to choose the path which exhibits the lowest error rate, so as to transmit, to the output S of the device, digital signals which correspond to those contained in the radio signals picked up by the two antennas 1A and 1B respectively.

It should be understood that the means making it possible to evaluate the performance levels and in particular the error rate for a given path may possibly be incorporated into the decoders respectively designed for the various paths, each of these decoders supplying for example an error rate indication for the path equipped therewith. A comparison of the rate indications respectively supplied by the various decoders is then capable of being utilized to select a path, under the conditions alluded to hereinabove, and hence in particular a path which exhibits a zero error rate or which is the lowest of the rates so compared.

According to the invention, additional means are also provided so as to make it possible to determine, from among the paths simultaneously exhibiting identical and optimal performance in terms of binary error rate, that one which is capable of possessing the best safety margin as regards the performance whose evaluation is carried out and which consequently is capable of continuing for the longest time to ensure faithful transmission of the signals reproduced, if the quality of the signals received drops significantly.

For this purpose, there is provision to utilize the property exhibited by the decoders, when the latter are designed to produce a faultless signal or one with few faults from a signal received which contains indications making it possible to reconstruct it by correcting the errors which may occur therein on reception. As is known, such a correcting capability is in particular provided for in the decoders of digital signals transmitted in packets where the packets contain error correcting codes making it possible to reconstruct their content, so long as the error levels stay within specified limits.

According to the invention, there is therefore provision to associate with the evaluation means alluded to hereinabove, means by way of which it is possible to progressively degrade the signals transmitted to the decoders in such a way that it is possible to reach the limit onwards of which a first of the decoders no longer has the capability to maintain the performance level which it had up to then. This can be done without any consequence for the transmission of the signals received, within the framework of evaluating the safety margins of decoders processing the signals, when this evaluation is carried out with a view to determining the decoder exhibiting the best margin, insofar as at least one of the decoders retains its initial level of performance and hence makes it possible to maintain the quality of transmission ensured up to then.

It is possible to determine the decoder which has the lowest safety margin among two or more decoders simultaneously exhibiting one and the same performance level. This can therefore be utilized to select a decoder and consequently the corresponding path, for which the performance level determined is optimal and the safety margin potentially the highest.

In the example proposed, of digital signals transmitted in packets containing error correcting codes, it is therefore the increasing of the binary error rate for a path, when the signals received are artificially degraded, which makes it possible to establish the safety margin thereof.

This artificial degradation can be obtained via various technical means, such as noise generators, phase shifters, attenuators or amplifier with variable gain, or others placed upstream of the decoders, these means being here referenced 9A or 9A′ and 9B or 9B′. In a first embodiment, the degradation means consist, for example, of phase shifters respectively placed one between an interface module and a decoder, like the means 9A between the interface module 4A and the decoder 3A, or else between an antenna and an interface module, like the means 9A′ between the antenna 1A and the interface module 4A. A progressive phase shift can thus be effected by way of phase shifter means associated with the decoders and for example by the means 9A and 9B for the signals respectively received from the antennas 1A and 1B and transmitted to the decoders 3A and 3B. If these decoders exhibit one and the same zero binary error rate, it is possible to determine the one whose safety margin is the lowest and consequently whose error rate might be the first to increase. As indicated above, such an operation of determination with degradation affects only the decoder whose safety margin is the lowest. The signals produced by the other decoder can therefore generally be used to feed the output S of the switch 8 in the example proposed.

In the case of an embodiment with time division multiplexing as described previously and consequently, with pooling of the decoder for the various paths, the signal output from the decoder cannot possibly be allowed to become degraded since there is no means of choosing the output which would be error-free of another decoder. The solution thus consists in using the knowledge regarding the performance of the decoder to determine the binary error rate not to be exceeded at its input in order to guarantee a zero binary error rate at its output.

As indicated hereinabove, other means may be substituted for the phase shifters in order to artificially and temporarily degrade the signals which are transmitted to the decoders, in the phase of safety margin determination for the decoders.

In a preferred embodiment, the degradation means are means of monitoring the gain of the device which are utilized to reduce the power level of the signals, originating from the antennas, supplied to the decoders. This degradation is capable of being carried out upstream, downstream or at the level of the interface modules. As previously, it makes it possible to determine the decoder whose safety margin is the lowest among decoders exhibiting the same performance level at the start of an operation of margin determination. In the example proposed, this determination utilizes the evaluation modules 5A and 5B, which make it possible to determine which decoder 3A or 3B is the first one whose binary error rate is increased, when the gain is progressively reduced.

As indicated previously, various types of error correcting codes can be used in the invention. The use of certain codes, such as for example the Reed-Solomon code, carries out during decoding a counting of the errors corrected while decoding, or signal the bits or symbols corrected during decoding. The use of code making it possible to get the number of errors corrected immediately upon exit from the decoder entails the means for evaluating the performance level being included in the decoder 3A and 3B. The evaluation modules 5A and 5B and the coders 6A and 6B are then unnecessary.

1. A reception device comprising:
at least two paths for receiving signals,
means making it possible to correct errors affecting the signals received via a path, by utilizing indications incorporated into the signals which it receives,
means for evaluating the level of performance achieved according to a specified criterion of quality in terms of reproduction of signals for a path, these means of evaluation being utilized to determine, from the signals received, the performance level capable of being obtained after correction for each path, and
degradation means that degrade, before evaluation and correction, the signals received at the level of a path so as to reduce the performance level previously obtained for this path and to allow, consequently, evaluation of a safety margin, according to the quality criterion, for this path, with the aid of the means of evaluation.

2. The reception device, according to claim 1, wherein said device comprises gain control means making it possible to progressively degrade the signals received at the level of a path, upstream of the evaluation means and of the signal decoding means.

3. The reception device, according to claim 1, wherein said device comprises phase shifting means for making it possible to progressively degrade the signals received at the level of a path, upstream of the evaluation means and of the decoding means.

4. The reception device, according to claim 1 wherein said device is more especially designed to receive digital signals, this device being furnished with at least two signal reception paths, as well as:
with means for decoding the digital signals received including means making it possible to correct errors affecting them by utilizing error correcting codes incorporated into the signals,
with means for evaluating the binary error rate for each path, these means of evaluation being placed downstream of the decoding means,
with means for making it possible to progressively degrade the signals received at the level of a path, these means being positioned upstream of the evaluation means and of the decoding means designed for the signals.

5. The reception device, according to claim 1, wherein said device comprises means for degrading the signals received which are utilized in time-sharing mode between all or at least some of the paths, and also at least certain of the means for correcting the errors and evaluating the performance levels and margins which relate to the paths constituting the said all or some of the paths and with which the said degradation means are associated.

6. A method allowing the evaluation of the performance in terms of reproduction of the signals received by a device furnished with several paths via which the signals are capable of being received, this device comprising means for correcting the signals received via a path, within specified limits of correction, by utilizing indications incorporated into the signals and means for evaluating the performance of a path according to a specified criterion of quality in terms of reproduction of signals, before correction, wherein the method makes provision to degrade the signals received so as to make it possible to determine a safety margin per path, according to the quality criterion taken into account by the evaluation means, when the degradation imposed on the signals received via a path causes the decreasing of the performance level evaluated for this path.

7. The method according to claim 6, wherein said method makes provision to progressively and jointly degrade the signals received via various paths, for which one and the same level of performance is then indicated by the evaluation means, in order to determine at least that of these paths whose performance level decreases first and manifests a safety margin lower than that of the paths whose performance level is preserved, the said process making it possible to maintain the transmission of the signals in the phase of evaluation by the path or one of the paths whose performance level has remained unchanged.

8. The method according to claim 7, wherein the method makes provision for a selection from among several paths jointly exhibiting one and the same performance level by elimination of the path or paths whose performance level has decreased owing to an imposed degradation of the signals received, which is carried out jointly for the paths concerned.
